(19) United States
(12) Patent Application Publication
(10) Pub. No.: US 2022/0400004 A1
(43) Pub. Date: Dec. 15, 2022

(54) GENERATING KEYS

(71) Applicant: Hewlett-Packard Development Company, L.P., Spring, TX (US)

(72) Inventors: David Plaquin, Bristol (GB); Joshua Serratelli Schiffman, Washington, DC (US); Thalia May Laing, Bristol (GB)

(73) Assignee: Hewlett-Packard Development Company, L.P., Spring, TX (US)

(21) Appl. No.: 17/761,701

(22) PCT Filed: Oct. 16, 2019
(86) PCT No.: PCT/US2019/056468

§ 371 Date: Mar. 18, 2022

(51) Int. Cl. H04L 9/08; H04L 9/30

(52) U.S. Cl. CPC H04L 9/0869; H04L 9/30; H04L 9/0866

(57) ABSTRACT

In an example, a method includes obtaining an initial seed, a public parameter associated with a processing apparatus and an indication of a state of the processing apparatus. The method may further include generating, by the processing apparatus, a key corresponding to the state of the processing apparatus. The state of the processing apparatus may be based on a combination of the initial seed, the public parameter and the indication of the state.

### BACKGROUND

A computing device may be provisioned with a cryptographic identity for conveying trust in the computing device. For example, a secret for generating the cryptographic identity may be injected into the computing device during manufacture of the computing device. However, certain procedures such as may occur during manufacture of the computing device may be such that the cryptographic identity may not be trusted at certain times.

### BRIEF DESCRIPTION OF DRAWINGS

Non-limiting examples will now be described with reference to the accompanying drawings, in which:

FIG. 1 is a flowchart of an example method of generating a key;

FIG. 2 is a simplified schematic illustration of an example processing apparatus for implementing certain methods;

FIG. 3 is a flowchart of an example method of generating a key;

FIG. 4 is a simplified schematic illustration of an example apparatus for implementing certain methods; and

FIG. 5 is a simplified schematic illustration of an example machine-readable medium associated with a processor.

### DETAILED DESCRIPTION

A cryptographic identity may provisioned to a computing device in a secure or trusted environment. In some examples, a cryptographic identity may comprise a key certified by a trusted entity such as a certificate authority. The cryptographic identity provisioned to certain computing devices may be trusted in scenarios where the manufacturing process is relatively straightforward. The manufacturing process for certain computing devices such as smart cards or trusted platform modules, TPMs, may be entirely controlled by a trusted entity so that the cryptographic identity of such devices can be trusted.

However, there may be scenarios where a cryptographic identity provisioned to a computing device may not be fully trusted if certain changes can or have been made (e.g., during manufacture or after reboot) to the computing device. For example, an authorized entity may be allowed to change the state of the computing device during the manufacturing process. The state of the computing device may be changed in a joint test action group, JTAG, mode or debug mode or when a certain operating system (e.g., software version or firmware version) is used (e.g., during bootstrap, setup or for implementation of an update). However, such a change in state may provide an opportunity for an unauthorized entity to access certain capabilities of the computing device which would not otherwise have been accessible and potentially make unauthorized modifications to the computing device or make unauthorized use of the cryptographic identity, which may not be readily detectable via the cryptographic identity.

The stage of the manufacturing process during which it is possible to inject a secret into a computing device for the purpose of cryptographic identity provision may not necessarily correspond to the point at which the operating system (e.g., software, firmware or other instructions for operating the computing device and/or hardware of the computing device) can be trusted (e.g., at the end of the manufacturing process). For example, a computing device could have a manufacturing origin in a certain location where the secret could be injected into the computing device, be setup with a development operating system in another location and/or be in an environment sufficiently secure for cryptographic identity provisioning in a third location.

In some examples, multiple entities may be involved in the manufacture of a computing device, which may provide an opportunity for certain changes to be made to the computing device. For example, an original design manufacturer, ODM, may manufacture a computing device such as a PC, which may be shipped to a configuration center in a certain state (e.g., the PC may have a normal mode and a debug mode with different privileges to that of the normal mode). At the configuration center, the state of the PC may be changed (e.g., through a change in operating mode and/or by adding new hardware and/or software to the PC). The PC may then be shipped to a finishing center where further procedures such as a final operating system installation may be performed. The cryptographic identify of the computing device may be trusted in certain states such as when the computing device is in the normal mode. However, if the state of the computing device is changed (e.g., within a debug mode) by an entity that is not trusted, it may not be possible to trust the cryptographic identity provisioned to the computing device.

If it is possible for an entity to make an unauthorized change to the computing device and/or certify the cryptographic identity of the device following such an unauthorized change, it may be difficult to establish trust in an ecosystem of such computing devices that have or could have been modified in an unauthorized manner.

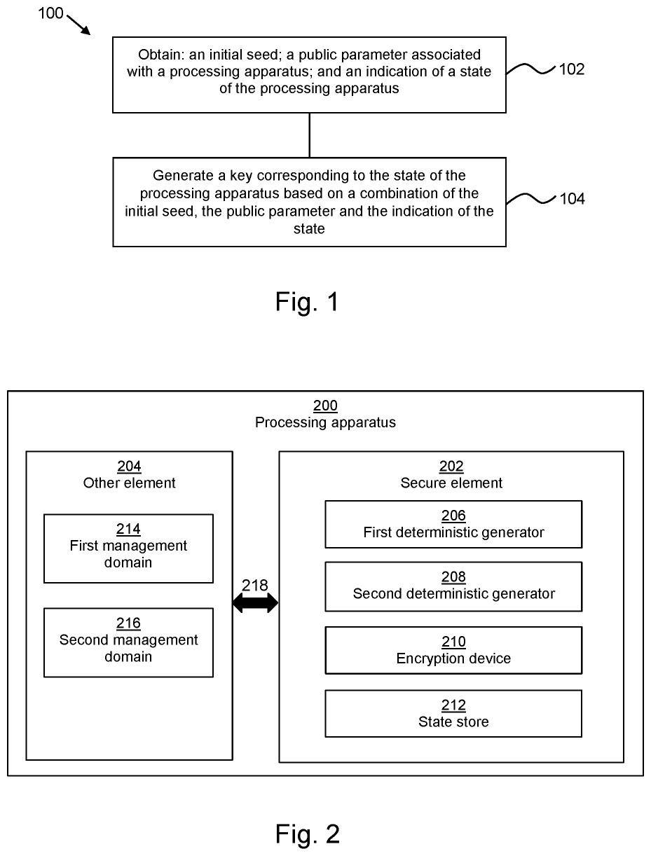

FIG. 1 depicts a flowchart of a method 100, which may be a computer-implemented method of generating a key (e.g., a cryptographic key usable in cryptographic operations such as in signature provision or encryption). In some examples, the method 100 may be implemented by a processing apparatus of a computing device such as a microcontroller, PC, etc.

The method 100 comprises, at block 102, obtaining: an initial seed; a public parameter associated with a processing apparatus; and an indication of a state of the processing apparatus.

In some examples, the initial seed (which may also be referred to as an ‘initialization value’ or ‘master seed’) may be obtained at an early or initial stage of the manufacturing process. The early or initial stage of the manufacturing process may be at a point where it is appropriate or safe (e.g., within a secure manufacturing environment) to inject the initial seed into the processing apparatus or otherwise cause the initial seed to be generated by the processing apparatus. In some examples, it may be difficult to physically access the processing apparatus or cause the processing apparatus to be placed in an appropriate state for generating or receiving the initial seed at a later stage of the manufacturing process (e.g., when the operating system might otherwise be trusted) to allow the initial seed to be injected or generated.

In some examples, the initial seed may be generated by a seed generator. The seed generator may derive the initial seed from a random sequence generator such as a true random number generator, TRNG or any other random number or character generator capable of providing a source of entropy. In some examples, the initial seed may correspond to a random sequence generated by the random sequence generator. In some examples, the initial seed may be generated using the random sequence as an input for the seed generator which, in some examples, may use a hashing function to produce the initial seed from the random sequence.

In some examples, the initial seed may be at least partially generated within a secure element (e.g., a secure component) of the processing apparatus. For example, a source of entropy such as provided by a TRNG may be generated externally (e.g., within the processing apparatus itself or injected by a manufacturer) of the secure element and the secure element may generate the initial seed from the source of entropy. In some examples, the secure element may generate the initial seed from the externally generated source of entropy along with entropy derived from the secure element itself. In some examples, the entropy derived from the secure element may be derived from (another) TRNG or any other mechanism capable of providing a random element for generating the initial seed such as a physically unclonable function, PUF or some unknown variation in the manufacturing process. In some examples, if the external environment is trusted, the secure element may generate the initial seed using the externally generated source of entropy (i.e., without a source of entropy derived from the secure element itself). Although in some examples the externally generated source of entropy may not be regarded as secret, the initial seed may be secret and/or may be unable to be determined by an entity such as a manufacturer. In some examples, providing at least part of the entropy used for generating the initial seed within the secure element (e.g., via a TRNH or PUF) is unknown to the external entity, an external entity may be unable to determine the initial seed (or at least it may be extremely challenging for the external entity to determine the initial seed). In some examples, a trusted entity may be aware of or able to determine the initial seed (e.g., if the trusted entity is tasked with injecting the initial seed).

In some examples, a manufacturer may use a computing device such as a server communicatively coupled to the processing apparatus to generate the initial seed, which may be injected into the processing apparatus. In some examples, the manufacturer may use the computing device to provide the source of entropy from which the processing apparatus itself may generate the initial seed.

In some examples, the public parameter (which may comprise a public key) may be associated with the processing apparatus. The public parameter may be representative of a public identity or label of the processing apparatus. Thus, the public parameter may be used to distinguish between the identities of different processing apparatus. The public parameter may be obtained from another element such as a management domain (which may be regarded as being public rather than secure or protected) of the processing apparatus. For example, a secure element may receive (e.g., upon request) or load the public parameter from a memory in the management domain.

The public parameter may have been generated prior to the secure element requesting the public parameter (e.g., the public parameter may have been provisioned by a manufacturing entity or caused to have been generated by the manufacturing entity) or may be generated (by the management domain of the processing apparatus) in response to the secure element requesting the management domain send the public parameter to the secure element. A secure interface or channel may be provided between the secure element and the management domain to avoid the public parameter becoming corrupted or being interfered with before being obtained by the secure element.

In some examples, the indication of a state of the processing apparatus may be determined by a secure element of the processing apparatus. In some examples, the state of the processing apparatus may be changed at different stages of manufacture e.g., to accommodate operating system updates or other changes. In some examples, the state of the processing apparatus may be changed during use (e.g., due to rebooting or in response to a user request to change the state).

In some examples, the indication of the state may be determined by a secure element of the processing apparatus (e.g., via a secure interface or channel linked to a component of the processing apparatus undergoing a state change). The secure element may store the indication of the state, which may be updated upon receiving an indication from the management domain that the state has or will be changed. In some examples, the state may be determined by determining the operating system that is booting. The management domain may decide or vouch for the trustworthiness of the operating system.

The method 100 further comprises, at block 104, generating, by the processing apparatus, a key corresponding to the state of the processing apparatus based on a combination of the initial seed, the public parameter and the indication of the state.

The key generated at block 104 may comprise a public key and a private key. The key may be used for cryptographic operations such as providing a signature or encryption purposes. The key may be regarded as being bound to the state of the processing apparatus. For example, the key may be described herein as a ‘condition key’, ‘state key’ or a domain-state bound key, ‘DSBK’.

As described previously, a change in state of the processing apparatus may provide an opportunity for an unauthorized entity to access certain capabilities of the processing apparatus which would not otherwise have been accessible and make unauthorized modifications to the processing apparatus, which may not be readily detectable or apparent from the cryptographic identity provisioned to a computing device comprising the processing apparatus.

Due to being bound to the state of the processing apparatus, the key may provide an indication as to whether unauthorized or unexpected modifications have been made to the processing apparatus. In some examples, certain changes of state may occur (e.g., during different manufacturing stages or during reboot). The cryptographic identity may or may not be trusted in certain stages depending on the nature of the change in state. Any unauthorized or unexpected change in state of the processing apparatus may be reflected in the key generated by the processing apparatus. A cryptographic identity (e.g., a certified key) provisioned to the processing apparatus may be protected since any unauthorized or unexpected change in state may become apparent by comparing the key generated by the processing apparatus with the expected or provisioned cryptographic identity of the processing apparatus.

The key generated by the processing apparatus may be trusted after certain state changes have occurred (e.g., at a certain manufacturing stage or boot state). Thus, any cryptographic identity (e.g., a signature) provisioned to the processing apparatus may be trusted since it may be possible to establish whether or not an unauthorized or unexpected change of state occurs or has occurred based on the key generated by the processing apparatus.

The key generation process may be deterministic in nature such that for the specified inputs (e.g., the initial seed, the public parameter and the indication of the state) such that it may be possible to establish whether the processing apparatus can be trusted depending on whether the key generated by the processing apparatus has been certified (e.g., by the management domain associated with the public parameter or an entity such as a trusted manufacturer that has determined (e.g., pre-computed) an expected future key of the processing apparatus).

In some examples, the processing apparatus may be provisioned with its identity providing the key can be certified. In some examples, the key may be certified by an end user or authorized entity to determine whether the public key generated by the processing apparatus corresponds to an expected public key for the specified initial seed, public parameter and expected state of the processing apparatus. If the key generated by the processing apparatus does not match with the expected key, this may indicate that the state of the processing apparatus is not as expected. In some examples, further action may be taken if the key is unable to be certified to determine if the manufacturing process has not been conducted as expected in order to decide if remedial action needs to be taken. In some examples, an end user or other entity may determine that the processing apparatus needs to be modified (e.g., through a further change in state) and the key regenerated and analyzed to determine whether or not the key can be certified.

As explained previously, in some examples, certain operations may be performed by a management domain of the processing apparatus and certain operations may be performed by a secure element of the processing apparatus. However, separation of the injection of the initial seed (or injecting the source of entropy) and the provisioning of the identity in the manufacturing process may pose certain risks in terms of being able to validly certify the identity provisioned to the computing device. Certain interactions between the secure element and the management domain may be performed in a secure manner (e.g., via secure interfaces or channels) in order to help establish trust in the key generated by the processing apparatus. When bound to the state of the processing apparatus, an end user or other entity may be able to sufficiently trust the key generated by the processing apparatus in order for that key to be certified. Further, since the provisioning of the identity and the injection of the initial seed or source of entropy may be securely separated from each other, an end user or other entity may be able to establish trust even if multiple entities, whether trusted or not, are involved in the manufacturing process.

FIG. 2 schematically depicts an example processing apparatus 200 comprising certain blocks for implementing certain methods described herein. The processing apparatus 200 comprises a secure element 202 (which may also be referred to as a secure component). In some examples, the secure element 202 may implement the method 100 of FIG. 1. The processing apparatus 200 further comprises another element 204, which may be communicatively coupled to the secure element 202 for the exchange (e.g., sending or receiving) of certain information for implementing certain methods described herein. In some examples, the other element 204 may implement the method 100 of FIG. 1. The secure element 202 may be configured such that a third party entity such as an unauthorized manufacturer is unable to access or otherwise compromise certain information stored or generated within the secure element 202. In some examples, another processing apparatus such as a server connectable to the processing apparatus 200 may implement the method 100 of FIG. 1.

The processing apparatus 200 comprises, within the secure element 202, a first deterministic generator 206, a second deterministic generator 208, an encryption device 210 and a state store 212. The processing apparatus 200 further comprises, within the other element 204, a first management domain 214 and a second management domain 216. The secure element 202 and the other element 204 of the processing apparatus 200 are connected by an interface 218, which in some examples may be a secure interface, to facilitate communication of certain information therebetween. The processing apparatus 200 may comprise further interface(s) (not shown) to facilitate communication of information such as key(s) and/or certificate(s) output by the processing apparatus 200 and/or input(s) such as a source of entropy by a manufacturer into the processing apparatus 200.

In some examples, the processing apparatus 200 may be used to generate a key within the secure element 202. In some examples, the processing apparatus 200 may be used to generate a key within the other element 204. In some examples, a key may be generated by another processing apparatus (such as a server controlled by a manufacturer). In some examples, the key generated within the secure element 202 may be compared with a key generated within the other element 204 or the other processing apparatus as part of an identity provisioning procedure.

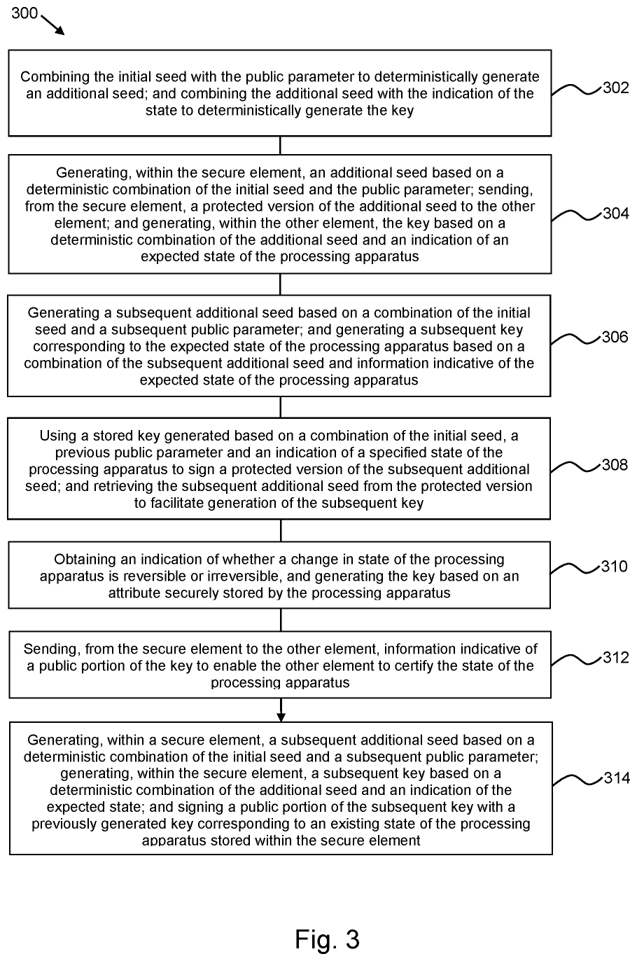

As will be described in more detail below with reference to FIG. 3, which depicts a flowchart of a method 300 for implementing certain methods described herein, the processing apparatus 200 may comprise certain components such as depicted in FIG. 2 for implementing certain methods described herein (whether implemented within the secure element 202 and/or the other element 204). Depending on the method being implemented, certain components depicted in FIG. 2 may be combined, modified or omitted from the processing apparatus 200. In some examples, the method 300 may be implemented in conjunction with or as part of the method 100 of FIG. 1.

In some examples, the method 300 comprises, at block 302, generating the key (e.g., by using the first deterministic generator 206) to combine the initial seed with the public parameter to deterministically generate an additional seed (which may be referred to as a domain-specific seed, DSS, since it is linked to the public parameter obtained from the first management domain). Block 302 further comprises (e.g., using the second deterministic generator 208) to combine the additional seed with the indication of the state of the processing apparatus 200 to deterministically generate the key. In some examples, block 302 may be implemented within the secure element 202 of the processing apparatus 200. Thus, a third party entity such as a manufacturer may not be able to access at least one of: the additional seed; and a private portion (e.g., a private key) of the key generated by the block 302. The other element 204 and/or a third party entity such as a manufacturer may communicate with the secure element 202 (e.g., via the interface 218 or another interface) in order to facilitate the generation of the key and/or a corresponding certificate within the secure element 202.

In some examples, the deterministic generation of the additional seed and the key may be performed by using the first and second deterministic generators 206, 208 to implement a key derivation function, KDF or other deterministic generator. Although the deterministic generation of the additional seed and key may be performed separately by the first and second deterministic generators 206, 208, in some examples, the key may be deterministically generated by a deterministic generator that deterministically combines the initial seed, public parameter and the indication of the state in a single stage (e.g., to enable a direct key certification from the inputs) or in two stages in a different sequence to that described by block 302.

In some examples, the method 300 comprises, at block 304, generating, within the secure element 202, an additional seed based on a deterministic combination of the initial seed and the public parameter (i.e., similar to block 302). Block 304 further comprises sending, from the secure element 202, a protected version of the additional seed to the other element 204. Block 304 further comprises causing, within the other element 204, generation of the key based on a deterministic combination of the additional seed determined from the protected version of the additional seed and an indication of an expected state of the processing apparatus 200. The expected state of the processing apparatus 200 may be known to or determined by the other element 204.

In contrast to block 302 where the key may be generated within the secure element, in block 304, the key may be generated in the other element 204. At least one of the blocks 302, 304 may be implemented as part of the method 300. In some examples, block 304 may be implemented to determine a key for an expected (e.g., future) state of the processing apparatus 200 and block 302 may be implemented to generate the key when the processing apparatus is subsequently in that state (e.g., so that the keys produced by blocks 302, 304 can be compared e.g., for certification purposes).

In some examples, the other element 204 may be able to access the expected state(s) and the public parameter but may not have access to the initial seed and/or the additional seed (e.g., since these may be protected within the secure element 202). The additional seed may be protected such that a third party entity such as a manufacturer cannot readily determine the additional seed (e.g., when it is sent to the other element 204).

In some examples, the interface 218 may be secured between the secure element 202 and the other element 204 such that the protected version can be sent to the other element 204 in a secure manner. For example, the additional seed may be encrypted (e.g., by the encryption device 210) within the secure element 202 and decrypted (e.g., by a decryption device (not shown)) within the other element 204. The encrypted additional seed may be referred to as an encrypted domain specific seed, EDSS, through being linked to the public parameter provided by the first management domain 214 of the other element 204. The protected (e.g., encrypted) version of the additional seed may be signed by a security device (such as a hardware security module (not shown) for securing the interface 218) before the protected version is sent to the other element 204.

In some examples, the processing apparatus 200 may be pre-populated with a cryptographic key (e.g., installed by a manufacturer) that is trusted within the other element 204. The protected version of the additional seed could be signed with this key and once the additional seed has been determined from the protected version (i.e., after decryption by the decryption device), the additional seed may be used alongside the public parameter and the expected state(s) of the processing apparatus 200 to generate and certify the key(s) corresponding to those expected state(s).

Block 304 may provide a way to ensure that an entity that has access to the other element 204 is unable to access or determine the initial seed and/or the additional seed but still allow the other element 204 to provision a cryptographic identity (e.g., certificate) corresponding to an expected or future state of the processing apparatus 200. For example, an entity that was previously involved in the manufacture of the computing device comprising the processing apparatus 200 may have been trusted to initiate the creation of the additional seed (e.g., through the provision of the source of entropy or injection of the initial seed). A subsequent entity (whether trusted or not) involved in the manufacture of the computing device may not be able to determine the initial seed or the additional seed. However, a certificate corresponding to a future or expected state of the processing apparatus 200 may still be issued without facilitating direct access to the initial seed and/or the additional seed held within the secure element 202 from the other environment 204.

During the lifetime of the computing device, the public parameter may be changed for various reasons at any time. For example, the public parameter may change if there is a change in ownership of the computing device, if the computing device is rebooted or to provide a way to facilitate a multi-tenant architecture where different computing devices are connected at different times to a particular service where different cryptographic identities may be created at these different times. In some examples, a public parameter may change if a new cryptographic identity is to be generated where a change of state occurs. Different authorities communicating with a computing device within a multi-tenant architecture may or may not be privileged to learn/know the cryptographic identity of the computing device. The provisioned cryptographic identity may specify whether a certain authority can learn/know its cryptographic identity. In some examples, a change in tenant may result in a change of the public parameter associated with the tenant(s). A new tenant may be able to determine whether or not to trust the cryptographic identities provisioned to the other tenant(s) since the change in state (e.g., due to the change of tenant) may be reflected in the provisioned cryptographic identity or identities.

In some examples where the public parameter may change, the method 300 comprises, at block 306, generating a subsequent additional seed based on a combination of the initial seed and a subsequent public parameter. Block 306 further comprises generating a subsequent key corresponding to the expected state of the processing apparatus based on a combination of the subsequent additional seed and information indicative of the expected state of the processing apparatus 200.

In some examples, the secure element 202 may store a key generated based on a combination of the initial seed, a previous public parameter (e.g., provided by the first management domain 214) and an indication of a specified (e.g., current or existing) state of the processing apparatus 200. The stored key may correspond to the specified state of the processing apparatus 200 at a particular time where the previous public parameter was used to generate the key. As explained above, the public parameter may change for various reasons such that a subsequent key can be generated and certified.

In some examples, the method 300 comprises, at block 308, using a stored key generated based on a combination of the initial seed, a previous public parameter and an indication of a specified state of the processing apparatus 200 to sign a protected version of the subsequent additional seed. Block 308 further comprises retrieving the subsequent additional seed from the protected version to facilitate generation of the subsequent key. The stored key may correspond to an existing state of the processing apparatus 200 and may be stored in the secure element 202 for long enough to allow the stored key to be used for signing the protected version of the additional seed. Since the protected version of the subsequent additional seed is signed by the stored key, which may be trusted by the other element 204, the other element 204 may be able to verify that that the protected version is trusted to enable the retrieval of the subsequent additional seed (e.g., after decryption).

The previous public parameter may correspond to an identity of the first management domain 214 of the processing apparatus 200. The key(s) generated by the other element 204 that correspond to expected state(s) of the processing apparatus 200 may be regarded as first management domain key(s). The subsequent public parameter may correspond to an identity of the second management domain 216 of the processing apparatus 200. The subsequent key(s) generated by the other element 204 that correspond to expected state(s) of the processing apparatus 200 may be regarded as second management domain key(s). Thus, where a public parameter may change, the corresponding keys(s) that are generated may correspond to certain management domain(s) 214, 216 of the processing apparatus 200, which may provide a secure way to ensure that the key(s) can be certified even if the public parameter changes. In some examples, a key generated as a result of a change in the public parameter may be linked to the second management domain 216 (e.g., if they have been certified in advance by this domain 216). In some examples, if the key generated with a public parameter associated with the first management domain 214 is linked to the second management domain 216 and is allowed to certify keys with different public parameters, this key may be used to certify key(s) generated from any new/subsequent public parameters.

Certain changes of state may be reversible. In some examples, the state of the processing apparatus 200 may be reset to a well-known state after running for a certain period of time (e.g., for a reboot). In some examples, a reversible state may be represented by a hash of a currently booted operating system and/or some other temporary information such as ownership details.

Other changes of state may be irreversible. In some examples, it may not be possible for the processing apparatus 200 to revert to a previous state. In some examples, an irreversible state may be achieved by triggering a one-time programmable,

OTP, fuse in the processing apparatus 200 that prevents the processing apparatus 200 from being reverted to a previous state. In some examples, a monotonic counter may be implemented such that the state of the processing apparatus 200 is specified according to the value of the counter. In some examples, a one-way cryptographic mechanism (e.g., a chain of hashes implemented by a platform configuration register, PCR, of a trusted platform module, TPM) to prevent access to the previous state may be used to protect the state of the processing apparatus 200 such that it is difficult to revert to a previous state of the processing apparatus 200. In some examples, an overall state (e.g., comprising the present irreversible state and reversible state, if applicable) of the processing apparatus 200 may be protected using a cryptographic hash. In some examples, the state(s) or protected version(s) of the state(s) may be stored within the state store 212 of the secure element 202 for future use. These stored state(s) may be updated upon receiving information (e.g., via the interface 218 between the secure element 202 and the other element 204) from the other element 204 indicating that a change of state has occurred.

The method 300 further comprises, at block 310, obtaining an indication of whether a change in state of the processing apparatus 200 is reversible or irreversible, and generating the key based on an attribute securely stored by the processing apparatus 200. In some examples, the attribute may be indicative of the state of the processing apparatus 200. In some examples, the attribute may comprise a counter, which may be bound to at least one of the additional seed and/or the state of the processing apparatus 200. The counter may be input to a KDF in order to generate the key. The counter may prevent any subsequent key generated by the KDF corresponding to (i.e., being bound to) a previous state since the KDF has as its input the counter (which is not reversible). In some examples, where the counter is indicative of the additional seed, the counter may correspond to a specified public parameter (e.g., a previous or new public parameter) that has been used to generate the additional seed. In some examples, the counter may be indicative of an irreversible change of state of the processing apparatus 200 such that any new key generated does not correspond to a previous state of the processing apparatus 200. In some examples, an iterative hash sequence may be used to represent or protect an irreversible state of the processing apparatus 200 (e.g., where the hash sequence is input to a KDF for generating the key), which may be similar to a TPM PCR extend operation. In some examples, a hardware OTP fuse may be used to represent or protect an irreversible state of the processing apparatus 200. Once the OTP fuse has ‘blown’ it may not be possible to revert to a previous state, and this may be reflected in the key as generated. Depending on whether the state of the processing apparatus 200 is reversible or irreversible, the secure element 202 may generate a key representative of either (or both) possible state(s) of the processing apparatus 200. An end user may then determine whether or not the processing apparatus 200 can be or has been returned to a previous state (i.e., providing that state is reversible). Securely storing the state of the processing apparatus 200 may ensure that the end user can trust the computing device, depending on whether or not it is acceptable for the processing apparatus 200 to be in a reversible and/or irreversible state at a specified time.

The method 300 comprises, at block 312, sending, from the secure element 202 to the other element 204, information indicative of a public portion of the key to enable the other element 204 to certify the state of the processing apparatus 200. The information indicative of the public portion of the key may be sent via a secure channel and/or the information may comprise a public key (as generated by the secure element 202) signed by a trusted entity such as a TPM prior to being sent to the other element 204.

In some examples, the other element 204 may have access to information (such as an expected public key corresponding to an expected state of the processing apparatus 200) to enable the other element 204 to determine whether or not the key received from the secure element 202 can be certified.

Once it has been determined that the public key can be certified, the other element 204 may issue a certificate for the public key. A single certificate may be issued for a given public key such that the other element 204 may be prevented from issuing further certificates until a new public key is generated. The other element 204 may not have any knowledge of the additional seed since it may receive the public key from the secure element 202 without being involved in the generation of the additional seed (i.e., as in block 304).

For block 312, the first management domain 214 may be implemented by the other element 204. The first management domain 214 may provide the public parameter and the present state of the processing apparatus 200.

In some examples, the method 300 comprises, at block 314, generating, within a secure element 202 of the processing apparatus 200, a subsequent additional seed based on a deterministic combination of the initial seed and a subsequent public parameter associated with an expected (e.g., future) state of the processing apparatus 200. Block 314 further comprises generating, within the secure element 202, a subsequent key based on a deterministic combination of the additional seed and an indication of the expected state of the processing apparatus 200 obtained from the other element 204 of the processing apparatus 200. With reference to block 312, where generating information indicative of the public portion of the key comprises, at block 314, signing a public portion of the subsequent key with a previously generated key corresponding to an existing state of the processing apparatus 200 stored within the secure element 202. Block 312 may allow a single certificate to be issued for a key corresponding to a current or existing state of the processing apparatus 200. However, block 314 may allow a single certificate to be issued at a time for an expected (e.g., future) state of the processing apparatus 200. The other element 204 may not have any knowledge of the subsequent additional seed since it may receive the (subsequent) public key from the secure element 202 without being involved in the generation of the subsequent additional seed (i.e., as in block 306).

For block 314, the first and second management domains 214, 216 may be implemented by the other element 204. The first management domain 214 may provide the public parameter and the present state of the processing apparatus 200. The second management domain 216 may provide the subsequent public parameter and the expected state of the processing apparatus 200.

In some examples, the methods 100, 300 described herein may be implemented within the secure element 202 of the processing apparatus 200. In some examples, the methods 100, 300 described herein may be implemented in another element 204 such as a management domain of the processing apparatus 200. In some examples, the methods 100, 300 described herein may be facilitated by an interaction between the secure element 202 and the other element 204. In some examples, the methods 100, 300 described herein may be implemented within a computing device such as a server controlled by a manufacturer. Thus, different entities (e.g., secure element 202 and/or the other element 204 of the processing apparatus 200, and/or another computing system such as a server) may be involved in the generation of key(s) and/or the issuance of certificate(s) corresponding to the state(s) or expected state(s) of the processing apparatus 200. In some examples, although certain methods described herein may be implemented within the secure element 202, corresponding or related methods may be implemented within the other element 204 (e.g., to facilitate the implementation of the methods within the secure element 202). Any of the blocks of the methods 100, 300 may be implemented within the secure element 202 and/or any of the blocks of the methods 100, 300 may be appropriately modified if implemented within the other element 204.

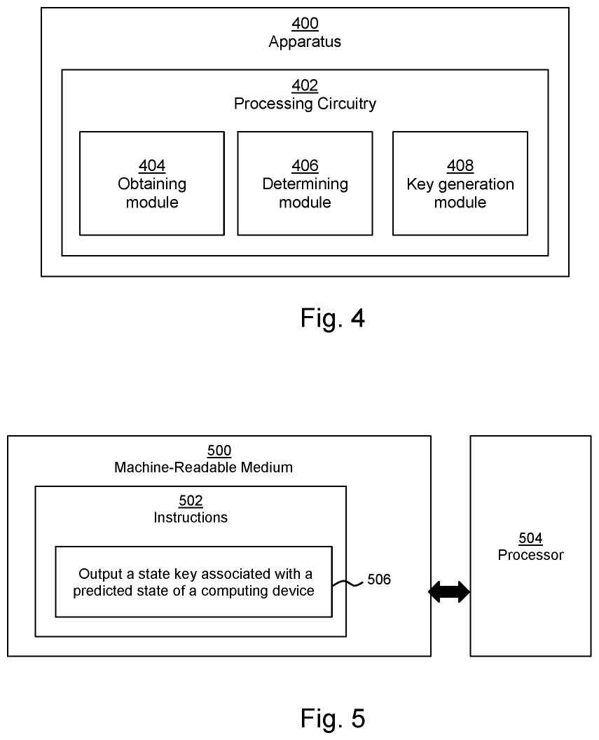

FIG. 4 is a schematic illustration of apparatus 400 for implementing certain methods described herein. Where appropriate, the apparatus 400 is described in relation to the components of FIG. 2 for ease of reference. The apparatus 400 may be used to generate a key, for example, as described in relation to the method 100 of FIG. 1 and/or the method 300 of FIG. 3. In some examples, the apparatus 400 may comprise the other element 204 described in relation to FIG. 2. In some examples, the apparatus 400 may comprise the secure element 202 described in relation to FIG. 2. In some examples, the apparatus 400 may comprise at least one component within at least one of the other element 204 and the secure element 202 of FIG. 2.

The apparatus 400 may implement certain methods described herein that are implemented in the other element 204 and/or the secure element 202. In other similar words, the apparatus 400 may comprise processing circuitry for implementing certain methods that are to be performed in at least one of: the other element 204 and the secure element 202.

The apparatus 400 (which may correspond to at least part of the processing apparatus 200 of FIG. 2) comprises processing circuitry 402. The processing circuitry 402 may, for example, carry out blocks of the methods described herein and/or execute the instructions stored on a machine readable medium (e.g., comprising instructions for implementing certain methods described herein).

The processing circuitry 402 comprises an obtaining module 404 (e.g., implemented in the ‘other element 204’ depicted in FIG. 2) to obtain, from a secure component (which may correspond to the ‘secure element 202’ of FIG. 2) of the apparatus 400, an indication of an input seed (which may correspond to the ‘additional seed’ described above) derived from a public key (which may correspond to the ‘public parameter’ described above) of the apparatus 400 and a master seed (which may correspond to the ‘initial seed’) accessible to the secure component.

The processing circuitry 402 comprises a determining module 406 to determine an expected condition (e.g., ‘state’) of the apparatus 400. In some examples, a management domain (e.g., corresponding to at least one of the first and second management domains 214, 216 of FIG. 2) may have access to or knowledge of the condition of the apparatus 400.

The processing circuitry 402 comprises a key generation module 408 to generate a condition key indicative of the condition of the apparatus 400 based on a deterministic combination of the input seed and the indicator of the expected condition of the apparatus 400. In some examples, the indicator of the condition may comprise a text string or other information specifying the condition of the apparatus 400 such as a present or expected boot state, manufacturing stage or any other information which may be combined with the input seed to deterministically generate the condition key.

In some examples, the processing circuitry 402 issues a certificate for the condition key corresponding to an expected condition of the apparatus 400 based on a deterministic calculation using the input seed from the secure component and an indicator of the expected condition of the apparatus 400. In some examples, the apparatus 400 may have knowledge or be able to determine the expected (e.g., future) condition of the apparatus 400. The certificate(s) issued by the processing circuitry 402 may be used by a subsequent entity or end user in the future to determine whether a present or actual condition (in the future) of the apparatus 400 corresponds to the expected condition of the apparatus 400 (e.g., to determine whether the identity of the apparatus 400 has been compromised since the certificate(s) were issued).

In some examples, where a subsequent input seed (e.g., an ‘additional seed’) is generated within the secure component, the processing circuitry 402 obtains (e.g., via the obtaining module 404), from the secure component, information from which the subsequent input seed can be derived by the processing circuitry 402. The processing circuitry 402 generates (e.g., via the key generation module 408), by the processing circuitry 402, a subsequent condition key corresponding to a subsequent expected condition of the apparatus 400 based on a combination of the subsequent input seed and the indicator of the expected condition of the apparatus 400. In some examples, the condition of apparatus 400 may be expected to change such that a new condition key is to be generated. In some examples, the apparatus 400 may update its condition key to reflect the change in condition such that a subsequent user or entity may trust that any certificate(s) issued by the apparatus 400 can be trusted in case any changes in condition have occurred previously.

In some examples, the processing circuitry 402 obtains (e.g., using the obtaining module 404), from the secure component, a subsequent input seed signed with a stored condition key generated based on a combination of the master seed, a specified public key and a specified indicator corresponding to a specified condition of the apparatus 400. In some examples, the processing circuitry 402 may verify the authenticity of the subsequent input seed since the stored condition key may be trusted. In some examples, the processing circuitry 402 may issue a certificate for the subsequent condition key corresponding to the expected condition of the apparatus 400 generated by the processing circuitry 402 based on a deterministic calculation using the subsequent input seed and the indicator of the subsequent expected condition of the apparatus 400.

In some examples, the processing circuitry 402 generates, within the secure component, the condition key corresponding to the condition of the apparatus 400 based on a deterministic combination using the input seed determined by the secure component and the indicator of the condition of the apparatus.

In some examples, where the processing circuitry 402 generates the condition key within the secure component, the processing circuitry 402 may determine (e.g., using the determining module 406) a subsequent public key to generate a subsequent input seed based on a combination of the master seed and the subsequent public key. The processing circuitry 402 may further determine (e.g., using the determining module 406) an indicator of an expected condition of the apparatus. The processing circuitry 402 may generate (e.g., using the key generation module 408) a subsequent condition key corresponding to the expected condition of the apparatus based on a deterministic combination of the subsequent input seed and the indicator of the expected condition of the apparatus.

In some examples, where the processing circuitry 402 generates a subsequent condition key, the processing circuitry 402 may store (e.g., in a tangible machine-readable medium) a specified condition key generated based on a deterministic combination of the master seed, a specified public key and an indicator of a specified condition of the apparatus. The processing circuitry 402 may use a portion of the specified condition key to certify a public portion of the subsequent condition key.

FIG. 5 schematically illustrates a machine-readable medium 500 (e.g., a tangible machine-readable medium) which stores instructions 502, which when executed by at least one processor 504, cause the at least one processor 504 to carry out certain example methods described herein (e.g., the method 100 of FIG. 1 or the method 300 of FIG. 3). In some examples described in more detail below, the machine-readable medium 500 may be implemented in a computing system such as a server controlled by an entity such as a manufacturer of the processing apparatus 200 or apparatus 400.

The instructions 502 comprise instructions 506 to cause the at least one processor 504 to output a state key (e.g., a key or condition key) associated with a predicted state of a computing device (e.g., the processing apparatus 200 or apparatus 400) based on an input. The input comprises an initialization value (e.g., an initial seed or master seed) specified for the computing device. The input further comprises a public key (e.g., a public parameter) associated with the computing device. The input further comprises a representation of the predicted state (e.g., an expected state) of the computing device. The machine-readable medium 500 may comprise or have access to information corresponding to the representation of the predicted state. In some examples, a manufacturer may be aware of which predicted state(s) the computing device is intended to have in the future. By using the representation of the predicted state(s), the machine-readable medium 500 may be capable of generating the state key(s) corresponding to those predicted state(s) before the computing device itself generates its own keys (i.e., when the computing device is actually in those state(s)).

In some examples, the instructions 502 cause the at least one processor 504 to compare information derived from the state key associated with the predicted state of the computing device with information derived from an actual state key generated by the computing device based on the initialization value, the public key and an actual state of the computing device, to determine whether or not the predicted state corresponds to the actual state of the computing device. In some examples, the machine-readable medium 500 may comprise instructions 502 which certify the key(s) generated by the instructions 506 (e.g., to generate certificate(s) corresponding to the certified key(s)). In some examples, the instructions 502 may cause the computing device to provide evidence that it possesses the corresponding state key so that this state key (which represents the present or actual state of the computing device) can be compared with the state key outputted by the at least one processor 504. A manufacturer may be trusted to inject or otherwise cause the computing device to generate the initialization value, and the manufacturer may generate certificate(s) corresponding to the future expected state(s) of the computing device so that a subsequent user or entity can verify whether the certificate(s) issued by the manufacturer correspond to the actual state of the computing device at a future point in the manufacturing process.

Certain methods described herein may be implemented within at least one of the secure element 202 and the other element 204 of the processing apparatus 200. Certain methods described herein may be implemented within at least one of the secure component and outside the secure component of the apparatus 400. In some examples, certain apparatus described herein may implement certain methods described herein and/or perform the function of other apparatus described herein. The processing apparatus 200 may implement certain methods within its secure element 202 and the apparatus 400 may implement certain methods outside its secure component. In some examples, the processing apparatus 200 may implement certain methods performed in the apparatus 400 within the other element 204 of the processing apparatus 200. In some examples, the apparatus 400 may implement certain methods performed in the processing apparatus 200 within the secure component of the apparatus 400. In some examples, the processing apparatus 200 and/or the apparatus 400 may be appropriately modified to implement any method described herein, depending on whether or not the method is to be performed in a secure element/component.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional environments of the processing apparatus 200 (for example, the secure element 202 and/or the other element 204) and/or functional modules of the apparatus 400 (for example, the obtaining module 404, determining module 406 and/or the key generation module 408) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
obtaining:
an initial seed;
a public parameter associated with a processing apparatus; and
an indication of a state of the processing apparatus; and
generating, by the processing apparatus, a key corresponding to the state of the processing apparatus based on a combination of the initial seed, the public parameter and the indication of the state.

2. The method of claim 1, where generating the key comprises combining the initial seed with the public parameter to deterministically generate an additional seed; and combining the additional seed with the indication of the state to deterministically generate the key.

3. The method of claim 1, where generating the key comprises:
generating, within a secure element of the processing apparatus, an additional seed based on a deterministic combination of the initial seed and the public parameter;
sending, from the secure element, a protected version of the additional seed to another element of the processing apparatus; and
causing, within the other element, generation of the key based on a deterministic combination of the additional seed determined from the protected version and an indication of an expected state of the processing apparatus.

4. The method of claim 3,
where generating the additional seed comprises generating a subsequent additional seed based on a combination of the initial seed and a subsequent public parameter; and
where generating the key comprises generating a subsequent key corresponding to the expected state of the processing apparatus based on a combination of the subsequent additional seed and information indicative of the expected state of the processing apparatus.

5. The method of claim 4, comprising:
using a stored key generated based on a combination of the initial seed, a previous public parameter and an indication of a specified state of the processing apparatus to sign a protected version of the subsequent additional seed; and
retrieving the subsequent additional seed from the protected version to facilitate generation of the subsequent key.

6. The method of claim 1, comprising sending, from the secure element to another element of the processing apparatus, information indicative of a public portion of the key to enable the other element to certify the state of the processing apparatus.

7. The method of claim 6, comprising:
generating, within a secure element of the processing apparatus, a subsequent additional seed based on a deterministic combination of the initial seed and a subsequent public parameter associated with an expected state of the processing apparatus;
generating, within the secure element, a subsequent key based on a deterministic combination of the additional seed and an indication of the expected state of the processing apparatus obtained from the other element of the processing apparatus; and
where generating information indicative of the public portion of the key comprises signing a public portion of the subsequent key with a previously generated key corresponding to an existing state of the processing apparatus stored within the secure component.

8. Apparatus comprising processing circuitry, where the processing circuitry is to:
obtain, from a secure component of the apparatus, an indication of an input seed derived from a public key of the apparatus and a master seed accessible to the secure component;
determine an expected condition of the apparatus; and
generate a condition key indicative of the expected condition of the apparatus based on a deterministic combination of the input seed and the indicator of the condition of the apparatus.

9. The apparatus of claim 8, where a subsequent input seed is generated within the secure component; and
the processing circuitry is to:
obtain, from the secure component, information from which the subsequent input seed can be derived by the processing circuitry; and
generate, by the processing circuitry, a subsequent condition key corresponding to a subsequent expected condition of the apparatus based on a combination of the subsequent input seed and the indicator of the expected condition of the apparatus.

10. The apparatus of claim 9, where the processing circuitry is to:
obtain, from the secure component, the subsequent input seed signed with a stored condition key generated based on a combination of the master seed, a specified public key and a specified indicator corresponding to a specified condition of the apparatus; and
issue a certificate for the subsequent condition key corresponding to the expected condition of the apparatus generated by the processing circuitry based on a deterministic calculation using the subsequent input seed and the indicator of the subsequent expected condition of the apparatus.

11. The apparatus of claim 8, where the processing circuitry is to generate, within the secure component, the condition key corresponding to the condition of the apparatus based on a deterministic combination using the input seed determined by the secure component and the indicator of the condition of the apparatus.

12. The apparatus of claim 11, where the processing circuitry is to:
determine a subsequent public key to generate a subsequent input seed based on a combination of the master seed and the subsequent public key;
determine an indicator of an expected condition of the apparatus; and
generate a subsequent condition key corresponding to the expected condition of the apparatus based on a deterministic combination of the subsequent input seed and the indicator of the expected condition of the apparatus.

13. The apparatus of claim 12, where the processing circuitry is to:
store a specified condition key generated based on a deterministic combination of the master seed, a specified public key and an indicator of a specified condition of the apparatus; and
use a portion of the specified condition key to certify a public portion of the subsequent condition key.

14. A tangible machine-readable medium storing instructions, which when executed by at least one processor, cause the at least one processor to:
output a state key associated with a predicted state of a computing device based on an input, the input comprising:
an initialization value specified for the computing device;
a public key associated with the computing device; and
a representation of the predicted state of the computing device.

15. The machine-readable medium of claim 14, where the instructions cause the at least one processor to:
compare information derived from the state key associated with the predicted state of the computing device with information derived from an actual state key generated by the computing device based on the initialization value, the public key and an actual state of the computing device, to determine whether or not the predicted state corresponds to the actual state of the computing device.
